(19) United States
(12) Patent Application Publication
(10) Pub. No.: US 2023/0375038 A1
(43) Pub. Date: Nov. 23, 2023

(54) BEARING ASSEMBLY FOR BEARING A DEVICE

(71) Applicant: Vibracoustic SE, Damstadt (DE)

(72) Inventors: Hilrich Kardoes, Winsen (DE); Philipp Werner, Lüneburg (DE); David Rose, Hamburg (DE)

(21) Appl. No.: 18/198,362

(22) Filed: May 17, 2023

(30) Foreign Application Priority Data
May 19, 2022 (DE) 10 2022 112 610.2

(51) Int. Cl. F16C 27/06

(52) U.S. Cl. CPC F16C 27/06; F16C 2380/00

(57) ABSTRACT

A bearing assembly for mounting a device, such as batteries or battery cases, includes a bearing and a receiving structure having a receiving opening that extends along a longitudinal axis. The bearing may have an elastomer body having a core that comprises a through-opening extending along the longitudinal axis for a connecting element. The bearing may further have a bearing element and an outer surface in the shape of a cylinder jacket extending about the longitudinal axis. In embodiments, the elastomer body bears against a contact surface of the bearing element, the receiving opening has an inner surface in the shape of a cylinder jacket, and the bearing is connected by an interference fit to the inner surface and the elastomer body having a conical area of effect. The invention provides, inter alia, a bearing assembly that can be premounted without a large degree of effort.

### CROSS-REFERENCE TO RELATED APPLICATIONS

This application claims priority to German Patent Application No. DE 10 2022 112 610.2, filed May 19, 2022, the contents of which are hereby incorporated by reference in its entirety.

### TECHNICAL FIELD

The invention relates to a bearing assembly for mounting a device including, for example, a battery or a battery case.

### BACKGROUND

In order to mount units, for example, of a vehicle, bearings are used which decouple the mounted unit from the retaining structure in terms of vibration. This is desirable in particular in vehicles so that, for example, damage is avoided. The bearing receives the unit to be mounted in a receiving structure which is connected to the retaining structure via an elastomer body. In this manner, vibrations of the retaining structure are damped by the elastomer bodies so that only damped and ideally no vibrations are transmitted to the unit.

DE 31 35 534 A1 discloses a bearing assembly which has two axially pretensioned bearings. Each bearing comprises an elastic body which is shaped to be externally conical and is arranged on a core. The elastic bodies are connected to the respective core. The elastic body with a corresponding receiving geometry can be coupled on the outer, conical geometry. A correspondingly conical outer metal is required as a receiver for the conical elastic body in order to provide a seat which is suitable for the elastic body.

If, during mounting, the conical bearing is plugged into a conical receiver, there is the risk that the bearing falls out of the receiver. If a bearing assembly of two conical bearings in opposite directions is used, the two bearings can be braced against one another, for example, by means of a screw. For this purpose, the bracing must take place immediately after placing the bearings in the receiver. Bracing at a later point in time after placing the bearing in the receiver is therefore only possible with significant effort or not at all.

### SUMMARY

An advantage of the invention is that it may provide a bearing assembly which can be premounted without significant effort.

Various aspects and features of the invention are disclosed herein.

In embodiments of a bearing assembly for mounting a device, such as batteries or battery cases, the bearing assembly may comprise at least one bearing and at least one receiving structure having a receiving opening which extends along a longitudinal axis, the at least one bearing having at least one elastomer body having a core, which comprises a through-opening extending along the longitudinal axis for a connecting element. In embodiments according to the invention, the least one bearing may further have at least one bearing element, the bearing may have an outer surface in the shape of a cylinder jacket which extends about the longitudinal axis, the elastomer body may bear against a contact surface of the bearing element, the receiving opening may have an inner surface in the shape of a cylinder jacket, and the at least one bearing may be connected by interference fit to the inner surface and the elastomer body having a conical area of effect.

With embodiments of the invention there is provided a bearing assembly, the bearing of which is connected by interference fit to the receiving structure and is premounted in this manner. The elastomer body of the bearing can be connected via the bearing element to the receiving opening of the receiving structure. With the bearing element there can furthermore be provided an adapter which transfers a possibly non-cylinder barrel-shaped outer surface of the elastomer body into an outer surface in the shape of a cylinder jacket of the bearing. The bearing element and the elastomer body can have contact surfaces which fit one another for this purpose and bear against one another in the mounted state. As a result of the outer surface in the shape of a cylinder jacket of the bearing, a receiving opening with an inner surface in the shape of a cylinder jacket can be provided in the receiving structure. A receiving opening configured in such a manner can be provided by means of a casting process, welding process or in exceptional cases with a low degree of effort, for example, by means of a bore. The bearing may be connected by means of interference fit to the inner surface in the shape of a cylinder jacket of the receiving opening. The bearing element can advantageously have a diameter perpendicular to the outer surface in the shape of a cylinder jacket which is slightly larger, e.g. in the range from 1 μm to 0.5 mm, preferably 0.2 mm, than the diameter of the receiving opening. Hence, in an embodiment, most or all of the bearing element may be disposed or arranged in the receiving opening as may be most or all of the area of effect. The elastomer body can likewise optionally contribute to the interference fit between the bearing and the receiving opening and/or bring about the interference fit between the bearing and the inner surface if the elastomer body has a larger diameter than the receiving opening. If the interference fit is achieved exclusively by the elastomer body in cooperation with the receiving openings, it is therefore also possible in this case that the outer diameter of the bearing element is smaller than the inner diameter of the receiving opening. Then, the bearing element being at least partly disposed or arranged in the receiving opening will not contribute to the interference fit. Also in this embodiment, most or all of the area of effect may be disposed or arranged in the receiving opening. Due to the interference fit, the risk of the bearing falling out of the receiving opening is minimized. Easy premounting of the bearing assembly is furthermore enabled by the interference fit between the bearing and the receiving opening. If the assembly has more than one bearing, a bracing of the bearings is not necessary for premounting. The bracing can take place during final mounting with a chronological gap and at a different location to the premounting.

The bearing element can, in combination with the inner surface, provide a conical area of effect on the elastomer body. Compressive and shear stresses in the elastomer body can be induced within the conical area of effect by axial deflection movements. Compressive stresses are primarily induced outside the conical area of effect by deflection movements. In this range, the elastomer body cannot escape in the event of deflections. This range can also be referred to below as the dead range. The conical shell surface of the conical area of effect accordingly represents the boundary, beyond which shear stresses can be ignored in the event of an axial deflection.

According to one embodiment, the contact surface can be formed to be conical in relation to the longitudinal axis.

In particular in the case of contact surfaces, the invention brings about that the bearing element which is shaped to be externally cylindrical in this case enables a premounting of an at least partially conically shaped elastomer body without the bearings having to be braced with a significant effort. The elastomer body can thus be formed with a conical outer surface which can be connected in an adhering manner by means of adhesive bonding or in a non-adherent manner by means of non-positive or positive connection on the corresponding contact surface of the bearing element. Compressive stresses in the elastomer body are induced by the conical outer surface in the event of an axial deflection, which compressive stresses can lead to a long service life. As a result, the bearing has overall progressive rigidity in the axial direction. In this embodiment, almost the entire elastomer body can be formed from the conical area of effect. The regions disposed or arranged outside the conical area of effect can be filled up by the bearing element and be disposed or arranged e.g. beyond the contact surface in relation to the elastomer body.

It is furthermore conceivable that the contact surface can be formed to be, for example, annular and oriented perpendicular to the longitudinal axis.

In a radial direction in relation to the longitudinal axis, the contact surface in this embodiment thus extends between an inner circular delimitation and an outer circular delimitation. The inner circular delimitation can be disposed or arranged e.g. radially inwardly directed facing the core. The outer circular delimitation can be disposed or arranged e.g. on the radially outwardly directed side, facing the receiving opening. Here, it can adjoin the inner surface or be spaced apart therefrom. The elastomer body can then likewise have an outer surface in the shape of a cylinder jacket which bears against the inner surface of the receiving opening. The elastomer body thus does not have a conical contact surface and can increase or solely bring about the action of the interference fit during premounting. If the elastomer body brings about the interference fit on its own, the bearing element can, for example, have a smaller diameter than the receiving opening. The dead range of the elastomer body is differentiated from the conical area of effect in this embodiment by an imaginary conus surface which extends from the inner circular delimitation up to the approach to the receiving opening. The dead range only includes compressive and tensile stresses during a deflection movement, while shear stresses also prevail in the area of effect. Hence, the interference fit may act in a radial direction around the area of effect.

According to a further embodiment, the inner surface can have at least one projection with at least one bearing surface which extends radially to the longitudinal axis as an axial stop for the bearing element.

The maximum penetration depth of a bearing into the receiving opening of the receiving structure is restricted with the stop. As a result of this, the positioning of the bearings during premounting is simplified. Slipping of the bearings into the receiving opening during operation is furthermore avoided so that high axial loads can be transmitted. In particular if two bearings are provided in the receiving opening which are braced against one another during mounting, the projection prevents the bearing from slipping onto one another within the receiving opening. The projection brings about a positive fit for the respective bearing in a direction axially in relation to the longitudinal axis.

The bearing assembly can furthermore have, for example, at least two bearings which are disposed or arranged along a joint longitudinal axis, wherein the bearing elements of the bearings are oriented toward one another.

The bearings can be disposed or arranged at two opposite ends of the receiving opening and are braced against one another during mounting. Both bearings in this embodiment are introduced in each case with the bearing element first into the receiving opening.

According to one embodiment, the elastomer body can be connected in a firmly bonded manner to the bearing element.

The connection between the elastomer body and the bearing element can be performed e.g. by means of vulcanization. The position of the bearing element with respect to the rest of the bearing is thus fixed so that premounted is further facilitated.

In one alternative embodiment, the elastomer body can be disposed or arranged loose on the bearing element.

Adhesive on the bearing element and the working step to coat the bearing element as well as the placing of the bearing element into the vulcanization mold can thus be dispensed with.

According to another embodiment, the at least one bearing can have a sleeve element which is disposed or arranged between the elastomer body and the inner surface, the sleeve element bearing with a first surface against the inner surface and with a second surface against the elastomer body.

The action of the interference fit between the bearing and the inner surface of the receiving opening can be increased with the sleeve element. The action of the interference fit is increased with the sleeve element either in addition to the action of the interference fit provided by the bearing element or provided by the sleeve element alone. The sleeve element bears against the elastomer body radially to the longitudinal axis, whereas the bearing element bears against the elastomer body in a direction axially in relation to the longitudinal axis. The conical area of effect in the elastomer body can be displaced by the arrangement of the sleeve element. The statements in relation to the conical area of effect in connection with the inner surface then apply in an analogous manner to the sleeve element.

It is furthermore conceivable in one embodiment that the sleeve element can be fixed with the second surface on the elastomer body in a firmly bonded manner.

In this case, the sleeve element can be connected, for example, fixedly to the bearing element.

The bearing element and the sleeve element can be formed e.g. in one piece and/or from the same material.

According to one embodiment, the elastomer body can be disposed or arranged between a pretensioning element and the bearing element, the elastomer body bearing against the pretensioning element and the pretensioning element preferably being a disc.

The pretensioning element can preferably be connected to the elastomer body in a firmly bonded manner, for example, by means of vulcanization. If the elastomer body is connected to the pretensioning element in a firmly bonded manner, no relative movements occur between the elastomer body and the pretensioning element. No tribological wear thus occurs. High axial rigidities can furthermore be set. Alternatively, however, instead of a separate pretensioning element, another fastening structure connected to the core in a non-positive and/or positive manner, for example, the chassis or the frame, can also act as a pretensioning element. Thus, at least one separate pretensioning element can be dispensed with and the number of parts can be reduced.

The pretensioning element can adjoin the elastomer body on a side of the elastomer body opposite the bearing element, i.e. the elastomer body can extend between the pretensioning element and the bearing element. With the pretensioning element, an elastic deformation in an axial direction in relation to the longitudinal axis away from the bearing element can be reduced or entirely avoided.

It is furthermore, for example, conceivable that the pretensioning element can overlap the bearing element in relation to the longitudinal axis in an axial direction.

As a result of the overlap between the pretensioning element and the bearing element, the bearing can have particularly progressive characteristics in particular in the case of an annular contact surface and a substantially cylindrical elastomer body. The rigidity properties of the bearing are similar to the rigidity properties of a bearing with a conically shaped elastomer body.

Together with the pretensioning element, the bearing element thus brings about that, for example, as a result of axial pretensioning, in the case of an axial approximation large parts of compressive stresses into the elastomer body of the bearing can be induced.

According to one embodiment, the core can taper along the longitudinal axis at least in one portion.

The tapering can be performed in a radially inward direction with respect to the longitudinal axis. The rigidity properties of the bearings can thus be further adapted to the respective use.

It is furthermore, for example, conceivable that the elastomer body can have a radial free path in a direction radially with respect to the longitudinal axis in the direction of the core and/or in the direction of the inner surface.

The rigidity properties of the bearings can be further adjusted with the radial free path. The term free path may be understood as a distance or a volume which is free from solid material. A free path in the direction of the core can thus furthermore be formed as a distance between the bearing element and the core.

According to one embodiment, the bearing element can be comprised of cast material, such as preferably plastic or aluminum.

A bearing element formed in a corresponding manner to the elastomer body can thus be provided in a simple and low-cost manner.

Further features, details and advantages of the invention will become apparent from the wording of the claims and from the following description of exemplary embodiments on the basis of the drawings. In the drawings:

### BRIEF DESCRIPTION OF THE DRAWINGS

FIG. 1 shows a schematic sectional representation of a first embodiment of the bearing assembly;

FIG. 2 shows a schematic sectional representation of a second embodiment of the bearing assembly;

FIG. 3 shows a schematic sectional representation of a third embodiment of the bearing assembly;

FIG. 4 shows a schematic sectional representation of a fourth embodiment of the bearing assembly; and

FIG. 5 shows a schematic sectional representation of a fifth embodiment of the bearing assembly.

The entirety of the bearing assembly is referred to herein by the reference number 10.

### DETAILED DESCRIPTION

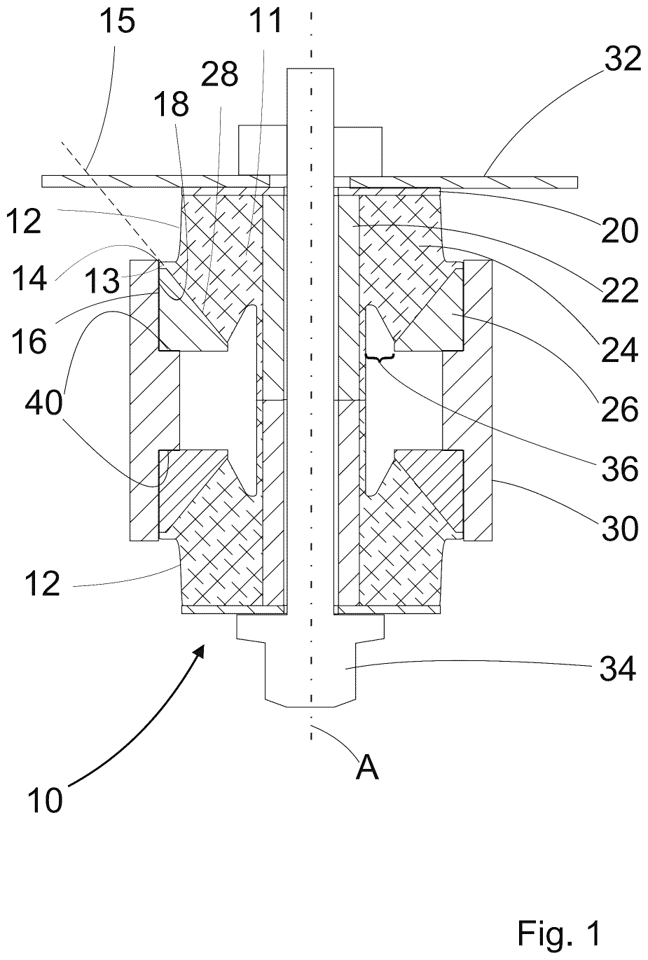

A first embodiment of the bearing assembly 10 is represented in FIG. 1 in a sectional representation. The bearing assembly 10 has, in this embodiment, two bearings 12 and a receiving structure 30. The receiving structure 30 has a receiving opening 14 which extends along a longitudinal axis A. In this embodiment, the receiving opening 14 is a through-opening. It is not ruled out in this case that the receiving opening 14 can be a blind hole.

The receiving opening 14 has an inner surface 18 which is formed to be cylinder barrel-shaped.

The bearings 12 are, in this embodiment, embodied to be structurally identical. Reference is therefore made below only to a bearing 12.

The bearing 12 has a core 22 with a through-opening. For example, a connecting element 34, which can be e.g. a screw or a bolt, can be guided through into the through-opening. The core 22 is, in this embodiment, formed to be cylindrical and extends along the longitudinal axis A.

Radially with respect to the longitudinal axis A, the bearing 12 has an elastomer body 24 which can be connected to the core 22 in a firmly bonded manner. The elastomer body 24 can be vulcanized e.g. onto the core 22.

The elastomer body 24 has a conical shape at least in an area of effect 11. This area of effect 11 extends about the longitudinal axis A. A spacing, which acts as a first radial free path 36 for the bearing 12, can be provided between the area of effect 11 with the conical shape and the core 22.

Compressive stresses in the elastomer body 24 are induced by the conical shape in the case of an axial deflection. As a result, the bearing 12 has overall a progressive rigidity in the axial direction.

The area of effect 11 is restricted in FIG. 1 by an imaginary conical surface 15. Outside the area of effect 11 with the conical shape, the elastomer body 24 can have in relation to the longitudinal axis A a diameter which can be smaller than the diameter of the receiving opening 14. A dead range 13 of the elastomer body 24 which only takes up minimal or no shear stresses in contrast to the conical area of effect 11 is disposed or arranged in the region outside the area of effect 11. On the contrary, compressive stresses dominate in this region, wherein shear stresses can still also occur in individual regions.

The bearing 12 furthermore has a bearing element 26 which has a contact surface 28. The elastomer body 24 bears against the contact surface 28 with the region which has the conical shape. The contact surface 28 is formed in a corresponding manner to the conical shape of the elastomer body 24. The elastomer body 24 can be vulcanized onto the contact surface 28. The elastomer body 24 can nevertheless alternatively bear against the contact surface 28 in a loose manner.

The bearing element 26 has an outer surface 16 which is formed in a cylinder barrel shape. The bearing element 26 as an adapter thus converts the conical shape of the elastomer body 24 into a cylindrical shape.

The bearing 12 is disposed or arranged in the receiving opening 14, wherein the bearing element 26 was introduced first into the receiving opening 14.

The bearing element 26 has, in this embodiment, prior to introduction into the receiving opening 14 transverse to the longitudinal axis A, a diameter which is greater than the diameter of the receiving opening 14 in the range from 1 μm to 0.5 mm, preferably 0.2 mm. An interference fit between the outer surface 16 of the bearing element 26 and the inner surface 18 of the receiving opening 14 is therefore produced during introduction of the bearing 12 into the receiving opening 14.

The interference fit between the outer surface 16 and the inner surface 18 fastens the bearing 12 in the receiving opening 14 without the need for screwing and reduces or avoids the risk of the bearing 12 falling out of the receiving opening 14.

The receiving opening 14 furthermore has a projection 40 which is disposed or arranged at a distance from the access point of the receiving opening 14. The projection 40 projects out of the inner surface 18 and reduces the diameter of the receiving opening 14 at its position.

The bearing 12 can therefore only be introduced up to the projection 40 into the receiving opening 14. The projection 40 thus acts as a stop for the bearing 12 and brings about a positive fit in the axial direction between the bearing 12 and the receiving structure 30. In this embodiment, the bearing element 26 bears against the projection 40. Forces which act in the axial direction on the bearing 12 are transmitted via the bearing element 26 to the projection 40. A slipping out of the bearing 12 as a result of axial forces which act on the bearing 12 into the receiving opening 14 is thus avoided.

The bearing 12 furthermore has a pretensioning element 20 which bears against the elastomer body 24 and against the core 22. Here, the pretensioning element 20 can be connected in a firmly bonded manner to the elastomer body 24. The elastomer body 24 is disposed or arranged between the pretensioning element 20 and the bearing element 26. The pretensioning element 20 can be disposed or arranged on a side of the elastomer body 24 opposite the bearing element 26. In the axial direction, the pretensioning element 20 overlaps with the bearing element 26.

The diameter of the elastomer body 24 in relation to the longitudinal axis A outside the region with the conical shape can be reduced to the outer diameter of the pretensioning element 20.

During mounting of the bearing assembly 10, the pretensioning element 20 bears on a side opposite the elastomer body 24 either against a connecting element 34 or against a fastening structure 32. The fastening structure 32 can be e.g. a chassis or a frame. The pretensioning element 20 can be formed as a disc.

A holding force which acts into the receiving opening 14 is transmitted to the bearing 12 via the pretensioning element 20.

In this embodiment, the two bearings 12 are disposed or arranged at two access points of the receiving opening 14, wherein the bearing elements 26 of the bearings 12 are directed toward one another. The pretensioning elements 20 of the two bearings 12 are disposed or arranged on sides of the bearings 12 which point away from one another.

The connecting element 34 is formed in this embodiment as a screw with which the bearing assembly 10 is fastened with a nut to the fastening structure 32.

For this purpose, the two bearings 12 premounted in the receiving structure 30 by means of the interference fit can be disposed or arranged without a great deal of effort at an intended position on the fastening structure 32. The entire bearing assembly 10 can be fastened to the fastening structure 32 by means of the connecting element 34. A user can hold the bearing assembly 10 during fastening e.g. to the receiving structure, wherein the bearings 12 remain in the receiving opening 14 by means of the interference fit in every orientation of the receiving opening 14.

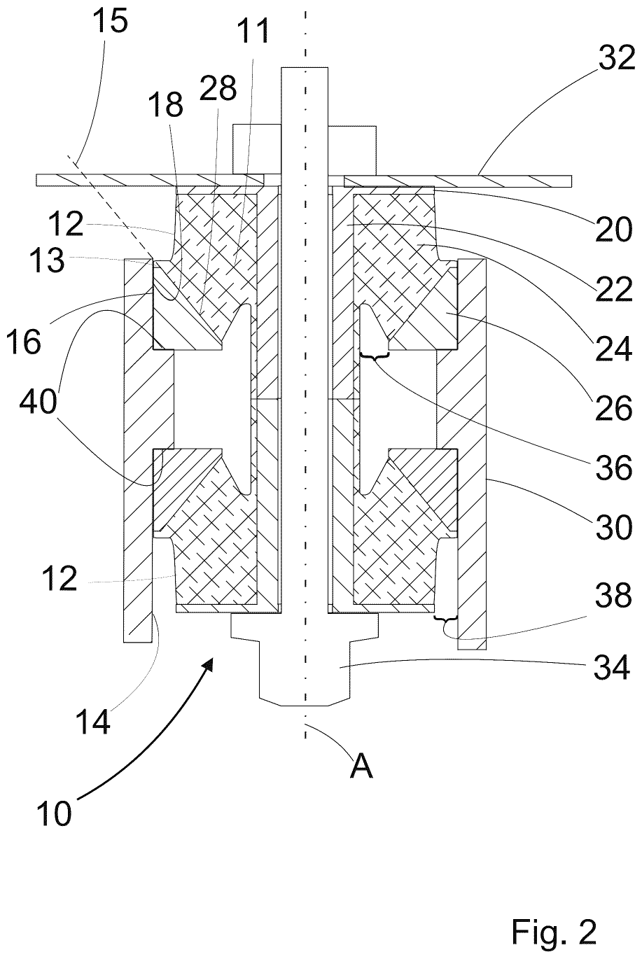

FIG. 2 shows a second embodiment of the bearing assembly 10. The reference numbers which are already known from FIG. 1 show the same elements as in FIG. 1.

In contrast to the embodiment from FIG. 1, the bearing assembly 10 from the embodiment from FIG. 2 has a core 22 and a pretensioning element 20 which are formed in one piece or of the same material. The number of parts of the bearings is thus reduced.

The receiving structure 30 from FIG. 2 in the axial direction is further formed to be longer than in FIG. 1. The bearing 12 represented at the bottom in FIG. 2 is therefore introduced deeper into the receiving opening 14 than the bearing 12 represented at the top in FIG. 2.

Since the elastomer body 24 outside the region with the conical shape has a smaller diameter than the receiving opening 14, a second radial free path 38 is produced between the elastomer body 24 of the bearing 12 represented at the bottom and the inner surface 18 of the receiving opening 14 represented at the bottom. The edge of the pretensioning element 20 directed radially outwards in relation to the longitudinal axis A acts in cooperation with the corresponding inner surface 18 as a radial stop.

The bearing 12 can thus have a high degree of progression in the radial direction.

It should be noted at this point that the one-piece embodiment of the core 22 and the pretensioning element 20 is independent of the position of the bearing 12 in the receiving opening 14. These two features can be provided independently of one another.

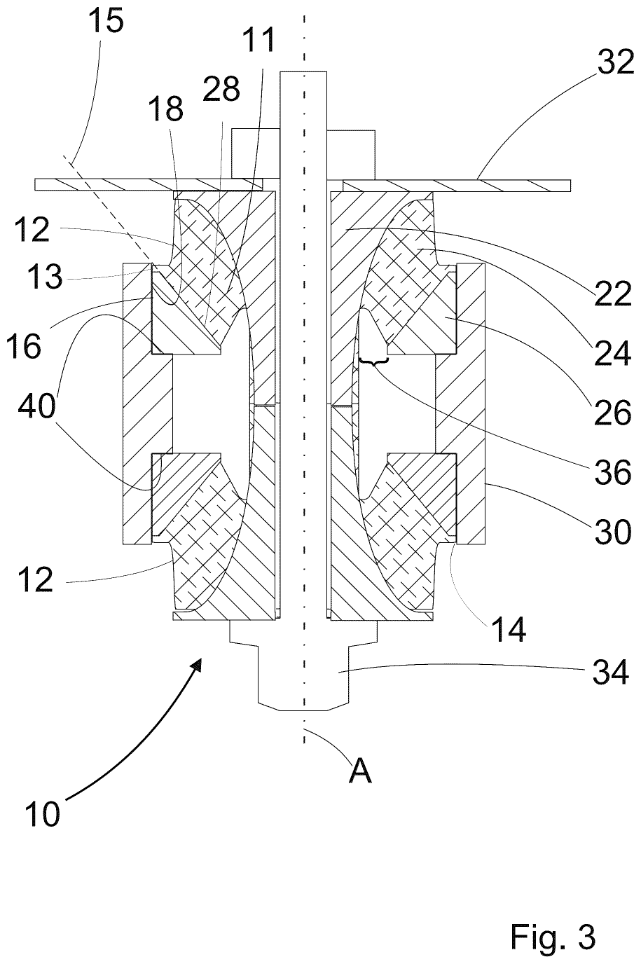

FIG. 3 shows a third embodiment of the bearing assembly 10. The reference numbers which are already known from FIG. 1 and FIG. 2 show the same elements as in FIG. 3.

In contrast to the embodiments from FIG. 1 and FIG. 2, the core 22 has a non-cylindrical shape. The core 22 tapers from the pretensioning element 20 along the longitudinal axis A.

The core 22 is furthermore formed as in the embodiment according to FIG. 2 in one piece with the pretensioning element 20.

Here, the core 22 can have a tapering shape without being formed in one piece with the pretensioning element 20.

The rigidity characteristics of the elastomer body 24 can be adapted with the tapering shape of the core 22.

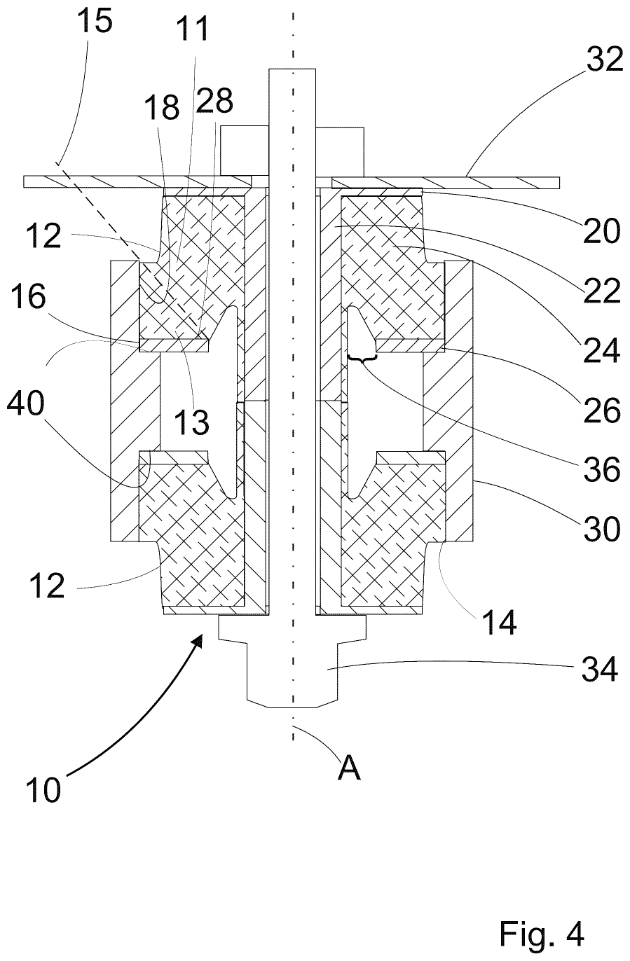

FIG. 4 shows a fourth embodiment of the bearing assembly 10. The reference numbers which are already known from FIGS. 1 to 3 show the same elements as in FIG. 4.

The core 22 and the pretensioning element 20 are formed in one piece as in the embodiment according to FIG. 2, but can also be provided separately from one another.

In contrast to the previous embodiments, the bearing element 26 has an annular contact surface 28 which extends about the longitudinal axis A, wherein the longitudinal axis A is disposed or arranged perpendicular to a plane which comprises the contact surface 28. The annular contact surface 28 is thus oriented perpendicular to the longitudinal axis A. The bearing element 26 is formed in this embodiment as a disc and overlaps the pretensioning element 20 in the axial direction.

Between an inner delimitation of the annular contact surface 28 facing the longitudinal axis A and the access point of the receiving opening 14, an imaginary conical surface 15 can divide the elastomer body 24 into the area of effect 11 and the dead range 13. Almost no shear stresses are induced in the dead range 13 as a result of axial deflection movements. On the contrary, compressive stresses dominate here and in isolated cases tensile stresses during a deflection movement. In addition to compressive and tensile stresses, shear stresses can also be induced only into the area of effect of the elastomer body 24 by means of axial deflection movements.

The overlapping brings about highly progressive characteristics of the elastomer body 24 during a deflection movement between the pretensioning element 20 and the bearing element 26.

The elastomer body 24 furthermore has, instead of a region with a conical shape, a region with a cylindrical shape. In addition or as an alternative to the bearing element 26, the region with the cylindrical shape of the elastomer body 24 can contribute to or solely bring about the interference fit between the bearing 12 and the inner surface 18. The bearing element 26 can then, for example, have a smaller diameter than the receiving opening 14 and be spaced apart from the inner surface 18.

The elastomer body 24 with a correspondingly annular surface bears against the contact surface 28. The elastomer body 24 can bear against the annular contact surface 28 in a loose manner. Alternatively, the elastomer body 24 can be vulcanized onto the annular contact surface 28.

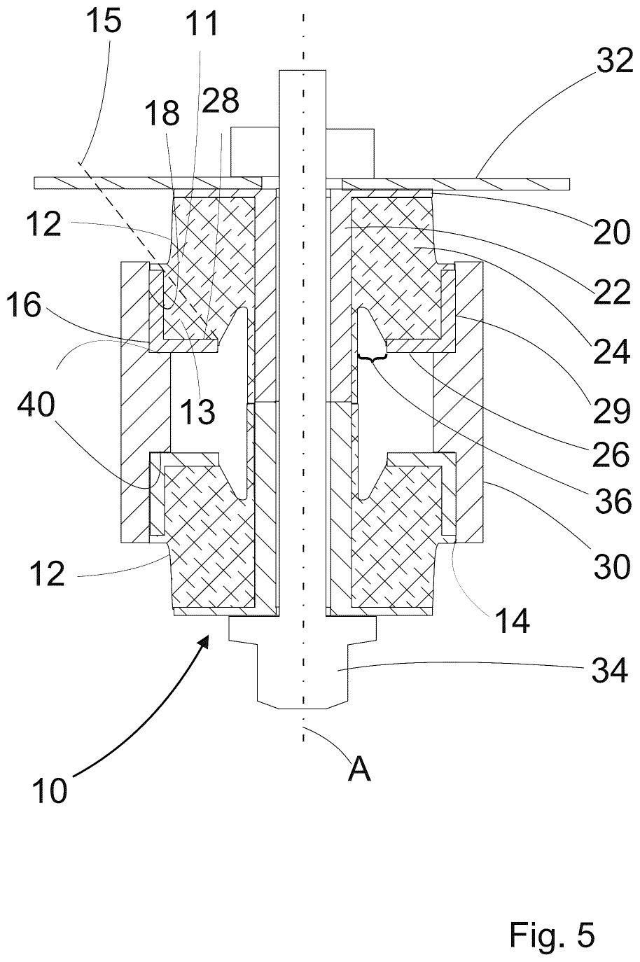

FIG. 5 shows a fourth embodiment of the bearing assembly 10. The reference numbers, which are already known from FIGS. 1 to 4, show the same elements as in FIG. 5.

The core 22 and the pretensioning element 20 are formed in one piece as in the embodiment according to FIG. 2, but can also be provided separately from one another.

In contrast to the embodiments of FIGS. 1 to 4, the bearing 12 has a sleeve element 29 which is disposed or arranged between the elastomer body 24 and the inner surface 18. Prior to the introduction of the bearing 12 into the receiving opening 14, the sleeve element 29 can have a diameter in relation to the longitudinal axis A, which is greater in the range from 1 μm to 0.5 mm, preferably 0.2 mm, than the diameter of the receiving opening 14. An interference fit is thus brought about between the sleeve element 29 and the inner surface during introduction of the bearing 12 into the receiving opening 14.

The sleeve element 29 is in this embodiment in one piece with or from the same material as the bearing element 26. Alternatively, the sleeve element 29 can have a component which is separate from the bearing element 26.

The invention is not restricted to one of the embodiments described above, but rather can be modified in various ways.

For example, the bearing element 26 can thus have a stepped region on the side which is disposed or arranged on the projection 40. A step can then bear in the axial direction against the projection 40, wherein the next step in the radial direction can bear against the projection 40 and is disposed or arranged further inward in the radial direction than the projection 40.

Alternatively or additionally, the elastomer body 24 can extend around the pretensioning element 20 and bear against a radially outwardly disposed or arranged side of the pretensioning element 20.

It is furthermore conceivable that the bearing element 26 on the outer surface 16 can have an elastomer layer. It is furthermore conceivable that alternatively or additionally the inner surface 18 can have an elastomer layer. The radial pretensioning force for the interference fit between the outer surface 16 and the inner surface 18 is then brought about by the elastomer layer.

All of the features and advantages which arise from the claims, the description and the drawing, including structural details, spatial arrangements and method steps, can be essential to the invention both alone and in the widest possible range of combinations.

1. A bearing assembly for mounting a device, the bearing assembly comprising:
a bearing having an elastomer body having a core that comprises a through-opening extending along a longitudinal axis for a connecting element, and
a receiving structure having a receiving opening that extends along the longitudinal axis,
wherein the bearing has a bearing element, the bearing has an outer surface in a shape of a cylinder jacket that extends about the longitudinal axis, the elastomer body bears against a contact surface of the bearing element, the receiving opening has an inner surface in the shape of a cylinder jacket, and the bearing is connected by an interference fit to the inner surface and the elastomer body having a conical area of effect.

2. The bearing assembly as claimed in claim 1, wherein the device comprises a battery or a battery case.

3. The bearing assembly as claimed in claim 1, wherein the contact surface is conical in relation to the longitudinal axis.

4. The bearing assembly as claimed in claim 1, wherein the contact surface is annular and is oriented perpendicular to the longitudinal axis.

5. The bearing assembly as claimed in claim 1, wherein the inner surface has a projection having a bearing surface extending radially with respect to the longitudinal axis as an axial stop for the bearing element.

6. The bearing assembly as claimed in claim 1, wherein the bearing assembly has a second bearing with a second bearing element disposed or arranged along a joint longitudinal axis, and the bearing element and the second bearing element are oriented toward one another.

7. The bearing assembly as claimed in claim 1, wherein the elastomer body is connected in a firmly bonded manner to the bearing element.

8. The bearing assembly as claimed in claim 1, wherein the bearing has a sleeve element that is disposed or arranged between the elastomer body and the inner surface, the sleeve element bearing with a first surface against the inner surface and with a second surface against the elastomer body.

9. The bearing assembly as claimed in claim 8, wherein the sleeve element is connected fixedly to the bearing element.

10. The bearing assembly as claimed in claim 1, wherein the elastomer body is disposed or arranged between a pretensioning element and the bearing element, the elastomer body bearing against the pretensioning element and the pretensioning element.

11. The bearing assembly as claimed in claim 10, wherein the pretensioning element comprises a disc.

12. The bearing assembly as claimed in claim 10, wherein the pretensioning element overlaps the bearing element in an axial direction in relation to the longitudinal axis.

13. The bearing assembly as claimed in claim 1, wherein the core tapers along the longitudinal axis at least in one portion.

14. The bearing assembly as claimed in claim 1, wherein the elastomer body has a radial free path in a direction radial to the longitudinal axis in the direction of the core and/or in the direction of the inner surface.

15. The bearing assembly as claimed in claim 1, wherein the bearing element is composed of a cast material.

16. The bearing assembly as claimed in claim 15, wherein the bearing element is composed of plastic or aluminum.

17. The bearing assembly as claimed in claim 1, wherein most of the bearing element and most of the conical area of effect are disposed inside the receiving opening.

18. The bearing assembly as claimed in claim 1, wherein the interference fit acts radially around the conical area of effect.
